(19) United States
(12) Patent Application Publication
(10) Pub. No.: US 2025/0138404 A1
(43) Pub. Date: May 1, 2025

(54) PROJECTOR DEVICE AND LIGHT SOURCE MODULE

(71) Applicant: Qisda Corporation, Taoyuan City (TW)

(72) Inventors: Hsin-Liang Chen, Taoyuan City (TW); Chun Ming Shen, Taoyuan City (TW)

(73) Assignee: Qisda Corporation, Taoyuan City (TW)

(21) Appl. No.: 18/916,663

(22) Filed: Oct. 15, 2024

(30) Foreign Application Priority Data
Oct. 31, 2023 (CN) 202311432758.8

(51) Int. Cl. G03B 21/20; G03B 21/16

(52) U.S. Cl. CPC G03B 21/204; G03B 21/16; G03B 21/208

(57) ABSTRACT

A projector includes a light source module, a light valve, and a projecting lens. The light source module includes a light-emitting element, a light diffusion assembly, a first structural component, and a first temperature-sensing element. The light-emitting element is adapted to emit an illumination light beam. The light diffusion assembly is adapted to diffuse the illumination light beam. The light diffusion assembly has a front end and a rear end opposite to each other, the front end of the light diffusion assembly faces the light-emitting element, and the rear end of the light diffusion assembly faces the first structural component. The first temperature-sensing element is disposed on the first structural component and corresponds to the light diffusion assembly. The light valve is adapted to convert the illumination light beam from the light source module into an image light beam. The projecting lens is adapted to project the image light beam.

### CROSS-REFERENCE TO RELATED APPLICATION

This application claims the priority benefit of China application serial no. 202311432758.8, filed on Oct. 31, 2023. The entirety of the above-mentioned patent application is hereby incorporated by reference herein and made a part of this specification.

### BACKGROUND

### Technical Field

This disclosure relates to a projector device and a light source module thereof, and particularly relates to a projector device including a light diffusion assembly and a light source module thereof.

### Description of Related Art

The application level of micro-projector devices is becoming increasingly widespread. The micro-projector devices may be applied to automotive illumination systems and are used with adaptive driving beam (ADB) technology as car lights to project driving information. If optical elements such as lens elements included in a light diffusion assembly and/or a wavelength conversion assembly in the micro-projector break due to unexpected factors, light rays transmitted therein will leak out and cause light hazards. Therefore, it is crucial to effectively establish a corresponding prevention system.

### SUMMARY

This disclosure provides a projector device and a light source module, which can avoid light hazards caused by breakage in an optical element.

A projector device of this disclosure includes a light source module, a light valve, and a projecting lens. The light source module includes a light-emitting element, a light diffusion assembly, a first structural component, and a first temperature-sensing element. The light-emitting element is adapted to emit an illumination light beam. The light diffusion assembly is adapted to diffuse the illumination light beam. The light diffusion assembly has a front end and a rear end opposite to each other. The front end of the light diffusion assembly faces the light-emitting element. The rear end of the light diffusion assembly faces the first structural component. The first temperature-sensing element is disposed on the first structural component and corresponds to the light diffusion assembly. The light valve is adapted to convert the illumination light beam from the light source module into an image light beam. The projecting lens is adapted to project the image light beam.

A light source module of this disclosure includes a light-emitting element, a light diffusion assembly, a first structural component, and a first temperature-sensing element. The light-emitting element is adapted to emit an illumination light beam. The light diffusion assembly is adapted to diffuse the illumination light beam. The light diffusion assembly has a front end and a rear end opposite to each other. The front end of the light diffusion assembly faces the light-emitting element. The rear end of the light diffusion assembly faces the first structural component. The first temperature-sensing element is disposed on the first structural component and corresponds to the light diffusion assembly.

In an embodiment of this disclosure, the illumination light beam is adapted to be incident into the light diffusion assembly along an incident direction. When viewing along the incident direction, the first temperature-sensing element overlaps the light diffusion assembly.

In an embodiment of this disclosure, a distance between the first structural component and the light diffusion assembly is smaller than a distance between the light diffusion assembly and the light-emitting element.

In an embodiment of this disclosure, the first structural component is a metal plate.

In an embodiment of this disclosure, the first structural component has a first surface and a second surface opposite to each other, the first surface faces the light diffusion assembly, and the first temperature-sensing element is disposed on the second surface.

In an embodiment of this disclosure, the light source module further includes a wavelength conversion element, a second structural component, and a second temperature-sensing element. The wavelength conversion element is adapted to convert a wavelength of the illumination light beam. The wavelength conversion element has a front end and a rear end opposite to each other, the front end of the wavelength conversion element faces a space between the light-emitting element and the light diffusion assembly, the rear end of the wavelength conversion element faces the second structural component, and the second temperature-sensing element is disposed on the second structural component and corresponds to the wavelength conversion element.

In an embodiment of this disclosure, the light source module further includes a semi-transmissive semi-reflective element. The semi-transmissive semi-reflective element is located on a transmission path of the illumination light beam. A part of the illumination light beam is reflected by the semi-transmissive semi-reflective element to the wavelength conversion element. Another part of the illumination light beam passes through the semi-transmissive semi-reflective element reach the light diffusion assembly.

In an embodiment of this disclosure, the wavelength conversion element and the second temperature-sensing element are disposed on a bearing surface of the second structural component.

In an embodiment of this disclosure, the second structural component is a heat sink.

In an embodiment of this disclosure, the illumination light beam is adapted to be incident into the light diffusion assembly along an incident direction, and the first temperature-sensing element and the second temperature-sensing element are located on a same side of the wavelength conversion element in the incident direction.

In an embodiment of this disclosure, the projector device is a car light.

In an embodiment of this disclosure, the light source module is a light source of the car light.

Based on the above, in the light source module of this disclosure, the first temperature-sensing element corresponding to the light diffusion assembly is disposed on the first structural component. Accordingly, when an optical element in the light source module is broken, causing a light beam passing through the light diffusion assembly to irradiate the first structural component in an abnormally large amount, the first temperature-sensing element may sense the abnormal temperature rise of the first structural component, thereby immediately turning off the light-emitting element to avoid light hazards caused by the breakage in the optical element.

### BRIEF DESCRIPTION OF THE DRAWINGS

FIG. 1 is a schematic view of a projector device according to an embodiment of this disclosure.

FIG. 2 is a perspective view of the projector device of FIG. 1.

FIG. 3 is a cross-sectional view of a partial structure of the projector device along a line I-I in FIG. 2.

### DETAILED DESCRIPTION OF DISCLOSED EMBODIMENTS

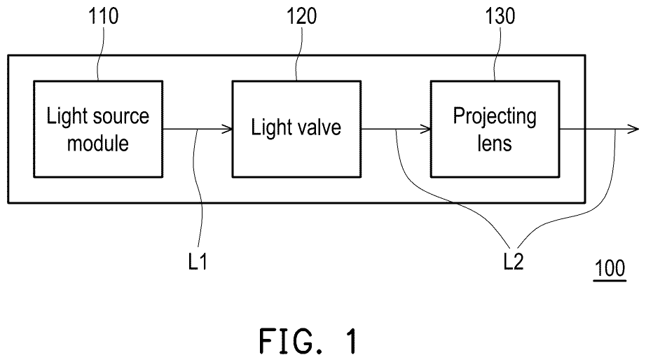

FIG. 1 is a schematic view of a projector device according to an embodiment of this disclosure. Please refer to FIG. 1. A projector device 100 of this embodiment includes a light source module 110, a light valve 120, and a projecting lens 130. The light source module 110 is adapted to emit an illumination light beam L1, the light valve 120 is adapted to convert the illumination light beam L1 from the light source module 110 into an image light beam L2, and the projecting lens 130 is adapted to project the image light beam L2.

In this embodiment, the projector device 100 is, for example, at least part of a car light, and the light source module 110 is a light source of the car light. Specifically, the projector device 100 may be a micro-projector device and is used with adaptive driving beam (ADB) technology as a car light to project driving information. In other embodiments, the projector device 100 may be other types of projector devices, and this disclosure is not limited thereto.

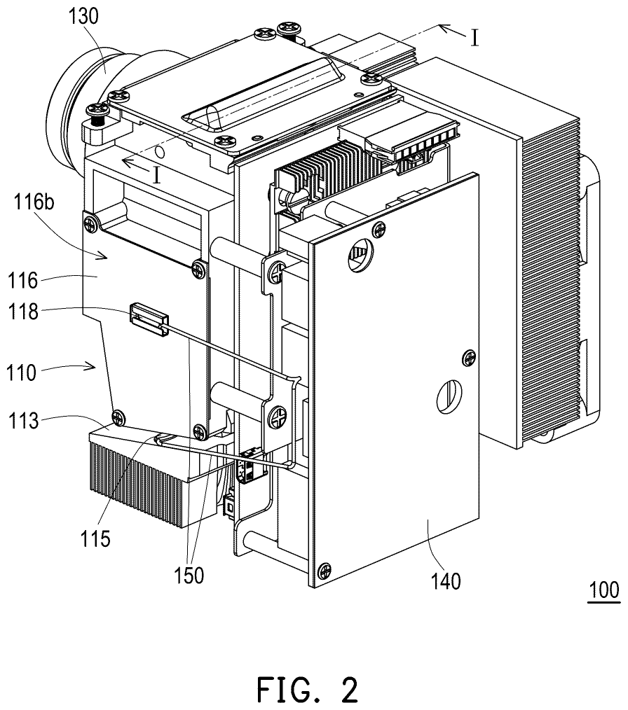

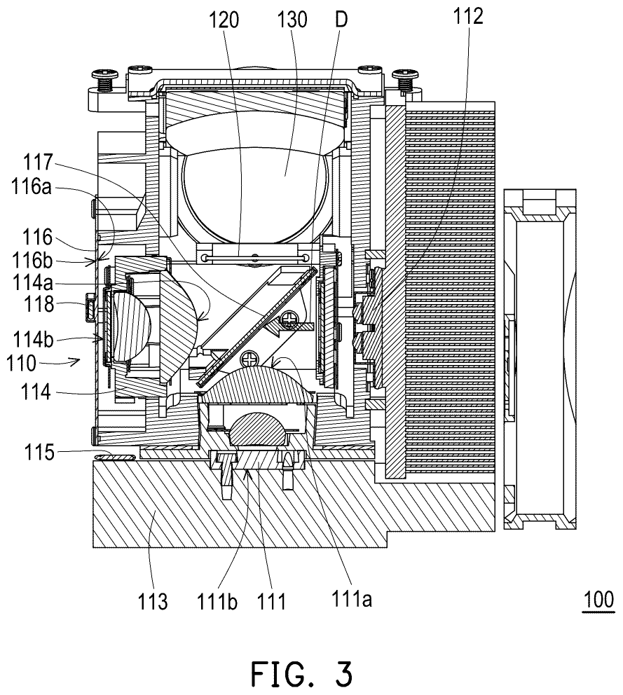

FIG. 2 is a perspective view of the projector device of FIG. 1. FIG. 3 is a cross-sectional view of a partial structure of the projector device along a line I-I in FIG. 2. Please refer to FIG. 2 and FIG. 3. The light source module 110 of this embodiment includes a light-emitting element 112, a light diffusion assembly 114, a semi-transmissive semi-reflective element 117, and a wavelength conversion element 111. The light-emitting element 112 is, for example, a blue laser source and is adapted to emit a blue light (i.e., the illumination light beam L1 shown in FIG. 1). The wavelength conversion element 111, the semi-transmissive semi-reflective element 117, and the light diffusion assembly 114 are located on a transmission path of the illumination light beam L1.

In detail, a part of the blue light emitted by the light-emitting element 112 is reflected by the semi-transmissive semi-reflective element 117 to the wavelength conversion element 111, and the wavelength conversion element 111 is adapted to convert a wavelength of the illumination light beam L1. For instance, the wavelength conversion element 111 may be a phosphor wheel and is used to convert the received blue light into a yellow light and then transmit the yellow light to the semi-transmissive semi-reflective element 117. The yellow light is transmitted to the light valve 120 through the semi-transmissive semi-reflective element 117.

Another part of the blue light emitted by the light-emitting element 112 reaches the light diffusion assembly 114 through the semi-transmissive semi-reflective element 117 and is diffused by the light diffusion assembly 114 and then transmitted to the semi-transmissive semi-reflective element 117. The blue light is reflected by the semi-transmissive semi-reflective element 117 and transmitted to the light valve 120. The blue light and the yellow light transmitted to the light valve 120 are synthesized into a white light. The light valve 120 is, for example, a digital micromirror device (DMD) or other types of light valve assemblies and is used to convert the white light into the image light beam L2 shown in FIG. 1 and transmit the image light beam L2 to the projecting lens 130.

The light source module 110 of this embodiment further includes a first structural component 116, a second structural component 113, a first temperature-sensing element 118, and a second temperature-sensing element 115. The light diffusion assembly 114 has a front end 114a and a rear end 114b opposite to each other. The front end 114a of the light diffusion assembly 114 faces the light-emitting element 112. The rear end 114b of the light diffusion assembly 114 faces the first structural component 116. The first temperature-sensing element 118 is disposed on the first structural component 116 and corresponds to the light diffusion assembly 114. The wavelength conversion element 111 has a front end 111a and a rear end 111b opposite to each other. The front end 111a of the wavelength conversion element 111 faces a space between the light-emitting element 112 and the light diffusion assembly 114. The rear end 111b of the wavelength conversion element 111 faces the second structural component 113. The second temperature-sensing element 115 is disposed on the second structural component 113 and corresponds to the wavelength conversion element 111.

As described above, in the light source module 110 of this embodiment, the first temperature-sensing element 118 corresponding to the light diffusion assembly 114 is disposed on the first structural component 116, and the second temperature-sensing element 115 corresponding to the wavelength conversion assembly 111 is disposed on the second structural component 113. Accordingly, when optical elements (such as the semi-transmissive semi-reflective element 117, a lens element and a reflector in the light diffusion assembly 114, and/or a lens element in the wavelength conversion element 111, etc.) in the light source module 110 are broken, causing a light beam passing through the light diffusion assembly 114 to irradiate the first structural component 116 in an abnormally large amount and/or causing a light beam passing through the wavelength conversion element 111 to irradiate the second structural component 113 in an abnormally large amount, the first temperature-sensing element 118 may sense the abnormal temperature rise of the first structural component 116 and the second temperature-sensing element 115 may sense the abnormal temperature rise of the second structural component 113. Then, a power control board 140 may immediately turn off the power of the light-emitting element 112 to avoid light hazards caused by breakage in the optical elements. In other embodiments, only the first temperature-sensing element 118 may be disposed without disposing the second temperature-sensing element 115, and this disclosure is not limited thereto.

The first structural component 116 of this embodiment is, for example, a metal plate installed behind the light diffusion assembly 114 and has a first surface 116a and a second surface 116b opposite to each other. The first surface 116a faces the light diffusion assembly 114. The first temperature-sensing element 118 is disposed on the second surface 116b. In addition, the second structural component 113 of this embodiment is, for example, a heat sink (such as a heat dissipation fin set) corresponding to the wavelength conversion element 111. The wavelength conversion element 111 and the second temperature-sensing element 115 are disposed on a bearing surface on the same side of the second structural component 113. However, this disclosure is not limited thereto. In other embodiments, the first structural component 116 and the second structural component 113 may be other types of structures, respectively. The first temperature-sensing element 118 and the second temperature-sensing element 115 may be disposed at other positions on the first structural component 116 and the second structural component 113, respectively.

In this embodiment, the illumination light beam L1 (shown in FIG. 1) emitted by the light-emitting element 112 is adapted to be incident into the light diffusion assembly 114 along an incident direction D (labelled in FIG. 3). When viewing along the incident direction D, the first temperature-sensing element 118 overlaps the light diffusion assembly 114. Moreover, a distance between the first structural component 116 and the light diffusion assembly 114 is smaller than a distance between the light diffusion assembly 114 and the light-emitting element 112. Accordingly, the first temperature-sensing element 118 can reliably sense the abnormal temperature rise of the light diffusion assembly 114 adjacent to the first structural component 116.

As shown in FIG. 3, in this embodiment, the first temperature-sensing element 118 and the second temperature-sensing element 115 are located on the same side of the wavelength conversion element 111 in the incident direction D. Accordingly, as shown in FIG. 2, a line 150 connected between the first temperature-sensing element 118/the second temperature-sensing element 115 and the power control board 140 may be conveniently disposed.

The first temperature-sensing element 118 and the second temperature-sensing element 115 of this embodiment may be negative temperature coefficient (NTC) thermistors. However, this disclosure is not limited thereto. In other embodiments, the first temperature-sensing element 118 and the second temperature-sensing element 115 may be other types of temperature-sensing elements.

To sum up, in the light source module of this disclosure, the first temperature-sensing element corresponding to the light diffusion assembly is disposed on the first structural component, and the second temperature-sensing element corresponding to the wavelength conversion element is disposed on the second structural component. Accordingly, when an optical element in the light source module is broken, causing the light beam passing through the light diffusion assembly to irradiate the first structural component in an abnormally large amount and/or causing the light beam passing through the wavelength conversion element to irradiate the second structural component in an abnormally large amount, the first temperature-sensing element may sense the abnormal temperature rise of the first structural component and the second temperature-sensing element may sense the abnormal temperature rise of the second structural component, thereby immediately turning off the light-emitting element to avoid light hazards caused by the breakage in the optical element.

What is claimed is:

1. A projector device, comprising:
a light source module, comprising:
a light-emitting element, adapted to emit an illumination light beam;
a light diffusion assembly, adapted to diffuse the illumination light beam, wherein the light diffusion assembly has a front end and a rear end opposite to each other, and the front end of the light diffusion assembly faces the light-emitting element;
a first structural component, wherein the rear end of the light diffusion assembly faces the first structural component; and
a first temperature-sensing element, disposed on the first structural component and corresponding to the light diffusion assembly;
a light valve, adapted to convert the illumination light beam from the light source module into an image light beam; and
a projecting lens, adapted to project the image light beam.

2. The projector device according to claim 1, wherein the illumination light beam is adapted to be incident into the light diffusion assembly along an incident direction, and when viewing along the incident direction, the first temperature-sensing element overlaps the light diffusion assembly.

3. The projector device according to claim 1, wherein a distance between the first structural component and the light diffusion assembly is smaller than a distance between the light diffusion assembly and the light-emitting element.

4. The projector device according to claim 1, wherein the first structural component is a metal plate.

5. The projector device according to claim 1, wherein the first structural component has a first surface and a second surface opposite to each other, the first surface faces the light diffusion assembly, and the first temperature-sensing element is disposed on the second surface.

6. The projector device according to claim 1, wherein the light source module further comprises a wavelength conversion element, a second structural component, and a second temperature-sensing element, the wavelength conversion element is adapted to convert a wavelength of the illumination light beam, the wavelength conversion element has a front end and a rear end opposite to each other, the front end of the wavelength conversion element faces a space between the light-emitting element and the light diffusion assembly, the rear end of the wavelength conversion element faces the second structural component, and the second temperature-sensing element is disposed on the second structural component and corresponds to the wavelength conversion element.

7. The projector device according to claim 6, wherein the light source module further comprises a semi-transmissive semi-reflective element, the semi-transmissive semi-reflective element is located on a transmission path of the illumination light beam, a part of the illumination light beam is reflected by the semi-transmissive semi-reflective element to the wavelength conversion element, and another part of the illumination light beam passes through the semi-transmissive semi-reflective element to reach the light diffusion assembly.

8. The projector device according to claim 6, wherein the wavelength conversion element and the second temperature-sensing element are disposed on a bearing surface of the second structural component.

9. The projector device according to claim 6, wherein the second structural component is a heat sink.

10. The projector device according to claim 6, wherein the illumination light beam is adapted to be incident into the light diffusion assembly along an incident direction, and the first temperature-sensing element and the second temperature-sensing element are located on a same side of the wavelength conversion element in the incident direction.

11. A light source module, comprising:
a light-emitting element, adapted to emit an illumination light beam;
a light diffusion assembly, adapted to diffuse the illumination light beam, wherein the light diffusion assembly has a front end and a rear end opposite to each other, and the front end of the light diffusion assembly faces the light-emitting element;
a first structural component, wherein the rear end of the light diffusion assembly faces the first structural component; and
a first temperature-sensing element, disposed on the first structural component and corresponding to the light diffusion assembly.

12. The light source module according to claim 11, wherein the illumination light beam is adapted to be incident into the light diffusion assembly along an incident direction, and when viewing along the incident direction, the first temperature-sensing element overlaps the light diffusion assembly.

13. The light source module according to claim 11, wherein a distance between the first structural component and the light diffusion assembly is smaller than a distance between the light diffusion assembly and the light-emitting element.

14. The light source module according to claim 11, wherein the first structural component is a metal plate.

15. The light source module according to claim 11, wherein the first structural component has a first surface and a second surface opposite to each other, the first surface faces the light diffusion assembly, and the first temperature-sensing element is disposed on the second surface.

16. The light source module according to claim 11, further comprising a wavelength conversion element, a second structural component, and a second temperature-sensing element, wherein the wavelength conversion element is adapted to convert a wavelength of the illumination light beam, the wavelength conversion element has a front end and a rear end opposite to each other, the front end of the wavelength conversion element faces a space between the light-emitting element and the light diffusion assembly, the rear end of the wavelength conversion element faces the second structural component, and the second temperature-sensing element is disposed on the second structural component and corresponds to the wavelength conversion element.

17. The light source module according to claim 16, further comprising a semi-transmissive semi-reflective element, wherein the semi-transmissive semi-reflective element is located on a transmission path of the illumination light beam, a part of the illumination light beam is reflected by the semi-transmissive semi-reflective element to the wavelength conversion element, and another part of the illumination light beam passes through the semi-transmissive semi-reflective element to reach the light diffusion assembly.

18. The light source module according to claim 16, wherein the wavelength conversion element and the second temperature-sensing element are disposed on a bearing surface of the second structural component.

19. The light source module according to claim 16, wherein the second structural component is a heat sink.

20. The light source module according to claim 16, wherein the illumination light beam is adapted to be incident into the light diffusion assembly along an incident direction, and the first temperature-sensing element and the second temperature-sensing element are located on a same side of the wavelength conversion element in the incident direction.
